(19) United States
(12) Patent Application Publication
(10) Pub. No.: US 2008/0220784 A1
(43) Pub. Date: Sep. 11, 2008

(54) METHOD AND APPARATUS FOR ADJUSTING A RESELECTION TIMER AND CELL RANKING CRITERIA, AND REPORTING DEGRADED SIGNAL MEASUREMENT OF A SERVING CELL

(75) Inventors: Shankar Somasundaram, Deer Park, NY (US); Mohammed Sammour, Montreal (CA)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: INTERDIGITAL TECHNOLOGY CORPORATION, Wilmington, DE (US)

(21) Appl. No.: 12/043,511

(22) Filed: Mar. 6, 2008

Related U.S. Application Data
(60) Provisional application No. 60/894,066, filed on Mar. 9, 2007.
(60) Provisional application No. 60/944,695, filed on Jun. 18, 2007.

(51) Int. Cl. H04Q 7/20; H04B 17/00

(52) U.S. Cl. 455/437; 455/438; 455/67.11; 455/550.1

(57) ABSTRACT

Various methods for adjusting a reselection timer and cell ranking criteria are disclosed. The ranking criteria of a serving or neighbor cell, or a reselection timer in a wireless transmit/receive unit (WTRU), is adjusted based on how a serving cell signal measurement, (e.g., signal strength, signal quality), compares to a plurality of thresholds over a time interval. In another method, cell ranking criteria is adjusted based on a hysteresis value and a scaling factor when a maximum number of reselections is exceeded and a high mobility factor is detected. Furthermore, a method of reporting cell signal measurements is disclosed, whereby a time-to-trigger time (TTT) interval is started when the neighbor cell signal measurement rises above a reporting range threshold. If the serving cell signal measurement falls below a serving cell threshold, the TTT interval is adjusted and thereby a measurement report is transmitted during the TTT interval.

### CROSS REFERENCE TO RELATED APPLICATIONS

This application claims the benefit of U.S. Provisional Application No. 60/894,066 filed Mar. 9, 2007 and U.S. Provisional Application No. 60/944,695 filed Jun. 18, 2007, which are incorporated by reference as if fully set forth.

### FIELD OF INVENTION

This application is related to wireless communications.

### BACKGROUND

The third generation partnership project (3GPP) has recently initiated the long term evolution (LTE) program to bring new technology, new network architecture and configurations, and new applications and services to wireless cellular networks in order to provide improved spectral efficiency, reduced latency, faster user experiences and richer applications and lower cost services. LTE aims at realizing an evolved universal terrestrial radio access network (UTRAN). This concept applies to LTE and also applies to all other universal mobile telecommunication system (UMTS) systems like release 99, high speed downlink packet access (HSDPA), high speed uplink packet access (HSUPA), high speed packet access (HSPA) enhancements, or any other releases.

In a UMTS system, when a WTRU is camped on a cell, the WTRU regularly searches for a better cell according to a set of criteria. If a better cell is found, that cell is selected. In earlier UMTS systems, cell reselection can per performed while the WTRU is in one of an idle state, a radio resource control (RRC) cell forward access channel (FACH) state and an RRC cell paging channel (PCH) state. In LTE with only two states, LTE_idle and LTE_active, the WTRU can perform cell reselection only in the LTE_idle state.

Reselection and handover are very different mechanisms. Reselection is performed by the WTRU in an RRC_idle state. Handover is performed by the WTRU in an RRC_connected state. Reselection is done autonomously, (i.e., based on some parameters signaled by the network). Handover is network controlled and directed.

In previous UMTS systems, before the WTRU decides to camp on a cell, it needs to check some basic criteria for the cell it is camping on. Essentially, conditions for quality signal metric S_{qual}>0 and received signal level metric Sᵣₓₗₑᵥ>0 need to be satisfied for the WTRU to camp on a cell, where S_{qual} and Sᵣₓₗₑᵥ are measured as:

S_{qual}=E_{c}/Iₒ−Q_{qualmin} Equation (1)

where E_{c} is the channel code power of the cell and Iₒ is the total interference in the cell. Thus, E_{c}/Iₒ is a dimensionless ratio of the average power of a channel, (i.e., pilot channel), to the total signal power, and is measured by the WTRU. Q_{qualmin} is the minimum required quality measure based on E_{c}/Iₒ. Qᵣₓₗₑᵥₘᵢₙ is extracted from a system information block 3 (SIB 3), which is broadcast by the system, and

Sᵣₓₗₑᵥ=RSCP−Qᵣₓₗₑᵥₘᵢₙ−max(WTRU_TXPWR_MAX_RACH−P_MAX,0), Equation (2)

where received signal code power (RSCP) is measured by the WTRU, and Qᵣₓₗₑᵥₘᵢₙ and WTRU_TXPWR_MAX_RACH are transmitted in SIB 3. Q_{qualmin} is the minimum required quality measure based on E_{c}/Iₒ, Qᵣₓₗₑᵥₘᵢₙ is the minimum required quality measure based on RSCP, and WTRU_TXPWR_MAX_RACH is the maximum allowed uplink (UL) transmission (TX) power) of a random access channel (RACH).

While in previous UMTS versions, the measurement quantity was E_{c}/Io or RSCP, in LTE the measurement quantity is not yet decided. The reference symbol received power (RSRP) is an LTE measurement that is analogous to RSCP. The reference symbol received quality (RSRQ) is also an LTE measurement that is analogous to E_{c}/Iₒ.

In addition to Q_{qualmin}, Qᵣₓₗₑᵥₘᵢₙ and WTRU_TXPWR_MAX_RACH, the following other parameters are transmitted in SIB 3 for cell reselection:

1) S_{intrasrch} (optional): The WTRU measures intra-frequency neighbor cells when S_{qual}, as defined by Equation (1), is less than or equal to S_{intrasrch}. If S_{intrasrch} is not specified by the network, the WTRU always measures intra-frequency neighbor cells.

2) S_{intersrch} (optional): The WTRU measures inter-frequency neighbor cells when S_{qual}, as defined by Equation (1), is less than or equal to S_{intersrch}. If S_{intersrch} is not specified by the network, the WTRU always measures inter-frequency neighbor cells

3) S_{searchRAT} (optional): The WTRU measures inter-RAT neighbor cells when S_{qual}, as defined by Equation (1), is less than or equal to S_{searchRAT}. If S_{searchRAT} is not specified by the network, the WTRU always measures inter-RAT neighbor cells. Always measure inter-RAT neighbor cells when not specified.

4) Q_{hyst1s}: This is a hysteresis value added to the serving cell signal quality, (as measured by RSCP), to increase the rank of the serving cell.

5) Q_{hyst2s}: This is a hysteresis value added to the serving cell signal quality, (as measured by E_{c}/Iₒ), to increase the rank of the serving cell.

6) Tᵣₑₛₑₗ: The time for which the neighbor cell should meet cell reselection criteria before the WTRU reselects to the neighbor cell.

The following are some of the important parameters transmitted in SIB 11:

1) Neighbor cell list (NCL).

2) Q_{offset1s}: Quality offset used to rank the serving cell based on RSCP.

3) Q_{offset2s}: Quality offset used to rank the serving cell based on E_{c}/Iₒ.

4) WTRU_TXPWR_MAX_RACH: Maximum allowed UL TX power for neighbor cell.

5) Q_{qualmin}: Minimum required quality measure based on E_{c}/Iₒ.

6) Qᵣₓₗₑᵥₘᵢₙ: Minimum required quality measure based on RSCP.

Using these parameters, the WTRU is able to rank its serving and neighbor cells. Serving cell ranking is given as:

Rank_{—}s=E_{c}/Iₒ+Q_{hyst2}+Q_{offmbms}. Equation (3)

The signaled value Q_{offmbms} is an offset added to those cells (serving or neighboring) belonging to the multimedia broadcast/multimedia service preferred layer (MBMS PL).

As mentioned above, Q_{hyst2s} is a static parameter indicated by the network to the WTRU in SIB 3 in the current UMTS systems for ranking of the serving cell.

Neighbor cell ranking is given as:

NRank_{—}n=E_{c}/Iₒ−Q_{offset2}+Q_{offmbms} Equation (4)

A ranking equation similar to Equation (4) may be applied when the measurement quantity is RSCP. For a particular cell to be reselected, the neighbor cell ranking has to be above the serving cell ranking for a period equal to Tᵣₑₛₑₗ. Even if the ranking of the serving cell falls rapidly, neither the ranking nor the value Tᵣₑₛₑₗ of a reselection timer is modified to reselect to the neighbor cell at a faster rate.

Other than the reselection criteria, a scalability factor for the high mobility state, (i.e., the WTRU is moving at a high speed) may be implemented. Accordingly, when the number of cell reselections that occur during a particular time period T_{CRmax} exceeds a value N_{CR}, a high mobility state has been detected. When a high mobility state is detected, the reselection timer value Tᵣₑₛₑₗ is multiplied by a scalability factor, if the scalability factor is signaled by the network as an optional parameter in SIB 3, depending on whether an intra or inter-frequency selection, or an inter-RAT selection, is being implemented.

There are many scenarios under which the above mobility condition would not be effective. For example, the WTRU may be in a fade from the serving cell, and not in a mobility scenario. In such a case, the WTRU may not be able to sustain a call and it would need to more rapidly reselect to the neighbor cell to prevent it from going out of service in the idle state, or to prevent the WTRU from losing data in other states, such as a FACH state.

Alternatively, the WTRU could be in high mobility scenario, but across a single large cell, so it might not meet the existing criteria of cell reselections. The serving cell could be dropping rapidly in such a case and again the WTRU would need to reselect to the neighbor cell quickly.

Alternatively, the WTRU may take a long time to reselect to a cell due to taking an extended time period to read the SIBs, or the WTRU may have gone out of service between cell reselections because the serving cell signal quality fell rapidly before the WTRU could reselect to another cell, in which case the WTRU may not even meet the criteria for a high mobility.

When the WTRU is in an active state, it needs to do a handover to a neighbor cell. In UMTS systems, this could either be a soft handover or a hard handover. In LTE, the WTRU is only allowed to do a hard handover.

In active state, the WTRU always measures the cells in its neighbor list which is sent in SIB 11 or in the measurement control message. If a neighbor list is truncated or removed as is being discussed in LTE, the WTRU could also search and detect neighboring cells and perform measurements on them.

When the neighbor cell exceeds a reporting range threshold, or meets an entry criteria, the WTRU initiates a time-to-trigger (TTT) that defines the minimum amount of time that the WTRU needs to wait before it can send a measurement report. A TTT timer may be used to establish the duration of the TTT. The TTT is specified in the SIB or measurement control message for each event. If the TTT expires and the neighbor cell remained above the threshold during the entire duration of a TTT, then a measurement report is triggered with the appropriate event. The network then responds with an active set update (ASU) or a handover command. If, during the TTT, the neighbor cell signal measurement, (e.g., signal strength, signal quality), falls below a preconfigured signal quality, then the TTT is terminated for that neighbor cell. The neighbor cell needs to return over the entry criteria for the WTRU to start measurements on the cell again.

If during the process, the serving cell signal rapidly fades, or the quality of the serving cell signal degrades, then the WTRU may not be in a position to receive the ASU or the handover command from the network. Also, the neighbor cell may fluctuate slightly above and below the threshold, causing the WTRU to start and stop the TTT. Hence, the WTRU may never manage to trigger the measurement report to reselect a neighbor cell.

In UMTS systems with soft handover, this problem is not seen predominantly. However, in LTE with no soft handovers, this problem may be more predominant. Thus, a more robust handover scheme that considers the WTRU serving cell condition is desired.

### SUMMARY

Various methods for overcoming the drawbacks of existing WTRU speed detection mechanisms in UMTS are disclosed. Existing WTRU speed detection mechanisms, and the way they are applied from UMTS, are not sufficient. Thus, signal measurement, (e.g., signal strength, signal quality), is used to overcome the drawbacks of the existing WTRU speed detection mechanisms. Correspondingly, some reselection parameters such as the hysteresis value and the time value Tᵣₑₛₑₗ of the reselection timer are modified. Also, the hysteresis quality value may be scaled by the existing WTRU speed detection techniques in UMTS. For handover, there may be scenarios where it is required to perform a serving signal measurement and modify the TTT. Thus, the TTT is modified according to WTRU speed since serving signal measurement correlates to WTRU speed.

A wireless communication method of adjusting the ranking criteria of a serving cell associated with a WTRU is disclosed herein. A signal measurement, (e.g., RSRQ, RSCP, RSRP), of the serving cell is performed. A serving cell hysteresis value is set to a first value if the signal measurement of the serving cell exceeds a first threshold. The serving cell hysteresis value is set to a second value if the signal measurement of the serving cell is less that the first threshold and is greater than a second threshold for a first time interval. The serving cell hysteresis value is set to a third value if the signal measurement of the serving cell is less than the second threshold for a second time interval. The ranking criteria of the serving cell is adjusted based on the serving cell hysteresis value after being set to one of the first value, the second value and the third value.

A wireless communication method of adjusting the ranking criteria of a neighbor cell associated with a WTRU is also disclosed herein. A signal measurement, (e.g., RSRQ, RSCP, RSRP), of the serving cell is performed. A neighbor cell offset value is set to a first value if the signal measurement of the serving cell exceeds a first threshold. The neighbor cell offset value is set to a second value if the signal measurement of the serving cell is less that the first threshold and is greater than a second threshold for a first time interval. The neighbor cell offset value is set to a third value if the signal measurement of the serving cell is less than the second threshold for a second time interval. The ranking criteria of the neighbor cell is adjusted based on the neighbor cell offset value after being set to one of the first value, the second value and the third value.

A wireless communication method of adjusting the ranking criteria of a serving cell associated with a WTRU is also disclosed herein. A reselection timer in the WTRU is set to a first value. A hysteresis value is set to a second value. A number of cell reselections associated with the WTRU that occur during a predetermined time period are monitored. Mobility factors associated with the WTRU are monitored. A determination is made as to whether to adjust the reselection timer by multiplying the first value with a first scaling factor, and/or adjust the ranking criteria of the serving cell by multiplying the second value of the hysteresis value with a second scaling factor, to reduce the ranking of the serving cell, if the number of cell reselections exceeds a third value, and a high mobility factor is detected.

A wireless communication method of adjusting a reselection timer in a WTRU is also disclosed herein. A signal measurement, (e.g., RSRQ, RSCP, RSRP), of the serving cell is performed. A reselection timer in the WTRU is set to a first value if the signal measurement of the serving cell exceeds a first threshold. The reselection timer is set to a second value if the signal measurement of the serving cell is less that the first threshold and is greater than a second threshold for a first time interval. The reselection timer is set to a third value if the signal measurement of the serving cell is less than the second threshold for a second time interval.

A cell signal measurement reporting method performed by a WTRU is also disclosed herein. A serving cell signal measurement and a neighbor cell signal measurement are performed. A TTT interval is started when the neighbor cell signal measurement rises above a reporting range threshold. If the serving cell signal measurement falls below a serving cell threshold, a measurement report is transmitted before the expiration of the TTT interval reporting that the serving cell signal measurement has fallen below the serving cell threshold and providing information about the neighbor cell used to generate a handover command. Alternatively, if the serving cell signal measurement falls below a serving cell threshold and stays below the threshold during a predetermined time interval, a measurement report is transmitted during the TTT interval reporting that the serving cell signal measurement has fallen below the serving cell threshold and providing information about the neighbor cell used to generate a handover command.

### BRIEF DESCRIPTION OF THE DRAWINGS

A more detailed understanding may be had from the following description, given by way of example in conjunction with the accompanying drawings wherein:

FIG. 1 shows the variation of various signals with time and other quantities used in handover decisions;

FIG. 2 is a flow diagram of a cell reselection process;

FIG. 3 is a flow diagram of a handover procedure using TTT scaling;

FIG. 4 shows an example of the configuration of a WTRU used to perform the methods disclosed herein;

FIG. 5 is a flow diagram of a wireless communication method of adjusting the ranking criteria of a serving cell associated with a WTRU;

FIG. 6 is a flow diagram of a wireless communication method of adjusting the ranking criteria of a neighbor cell associated with a WTRU;

FIG. 7 is a flow diagram of a wireless communication method of adjusting the ranking criteria of a serving cell associated with a WTRU;

FIG. 8 is a flow diagram of a wireless communication method of adjusting a reselection timer in a WTRU; and

FIGS. 9 and 10 are flow diagrams of cell signal measurement reporting methods performed by a WTRU.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of user device capable of operating in a wireless environment.

When referred to hereafter, the terminology “base station” includes but is not limited to a Node-B, a site controller, an access point (AP), or any other type of interfacing device capable of operating in a wireless environment.

In a first wireless communication method disclosed herein, LTE is the system focused upon, and RSRQ and RSRP are used as measurement quantities. Alternatively, other measurement quantities could be chosen without affecting the invention. The following may be applied to both current UMTS systems and LTE.

Q_{hyst1s} is a hysteresis value that is signaled. In the following method, this hysteresis value is scaled and a new hysteresis value called Q_{hyst} is introduced, which is based on a serving signal measurement, (RSRQ, RSCP, RSRP), which in turn is a measure of mobility.

A situation may arise in which the serving cell signal quality may fall too rapidly before the cell reselection occurs, or the criteria for high mobility might not be met. Thus, the WTRU would suffer from cell reselection failures. This problem may be addressed by taking the serving cell quality into account while doing cell reselection. While the criteria for camping on a cell may remain the same as in previous systems or be modified, modification of the ranking criteria itself and the reselection timer will now be disclosed.

Many variations for ranking the serving and neighbor cell are possible. Note that all equations below use the measurement quantity RSRQ, which as mentioned before is assumed to be analogous to E_{c}/Iₒ. A similar set of equations can be written with the measurement quantity RSRP, which as mentioned before is assumed to be analogous to RSCP. Note that in the equations below, the quantity RSRQ may be substituted by any other suitable “signal quality” measure, while the quantity RSCP may be by any other suitable “signal level” measure, or any other suitable measures.

For a serving cell, the ranking criteria is kept the same, namely:

Rank_s=RSRQₛ+Q_{hyst2s}+Q_{offmbms}, Equation (5)

where RSRQₛ is the reference symbol received quality of the serving cell.

For a neighbor cell, however, the ranking criteria is modified as:

Rank_{—}n=RSRQₙ−Min(Q_{offset2},Q_{hyst})+Q_{offmbms}, Equation (6)

where RSRQₙ is the reference symbol received quality of neighbor cell n, or in general,

Rank_{—}n=function(RSRQₙ,Q_{offset2}, Q_{offmbms},RSRQₛ). Equation (7)

By making Rank_n a function that is adapted based on RSRQₛ, we enhance the ranking criteria and avoid the potential problems of the existing cell reselection scheme.

An additional parameter may be introduced called Q_{hyst} which is applied by the WTRU as follows:

If RSRQₛ>x, Equation (8)

where x is a serving cell signal measurement threshold,

Q_{hyst}=z1 dB; Equation (9)

Else if for a time interval T₁₁, If x>RSRQₛ>y; Equation (10)

where T₁₁ is a timer value which indicates the interval of time during which RSRQ has to be between the 2 thresholds x and y.

Q_{hyst}=z3 dB. Equation (11)

Else, if RSRQₛ<y for a time interval T₁₂, Equation (12)

Q_{hyst}=z2 dB, Equation (13)

where z1>z3>z2 and x>y.

The values x, y, z1, z2, z3, T₁₁, and T₁₂ may either be implementation dependent, network defined or defined in standard after simulation results. T₁₁ and T₁₂ are the intervals of time for which the conditions for RSRQ have to be satisfied. The serving cell thresholds or Q_{hyst} values may be communicated dynamically via RRC messages, (e.g., in one or more SIBs).

When the WTRU serving cell signal measurement is below a threshold, the neighboring cell rank is improved by subtracting a lower value from the measurement quantity, which in this case is RSRQ. If the serving cell signal measurement is above a threshold, then the value Q_{offset2} or the quantities z1 or z3 may still be subtracted, depending on the threshold and depending on the values of z1 and z3. For the algorithm to work effectively, z2 must be at least less than Q_{offset2}.

Alternatively, we could have a two-level threshold where, above a value x, we can use a similar hysteresis value as used today in UMTS systems, or use a new hysteresis value z1. If the signal strength of the WTRU falls below a value x for a time interval T₁₃, a Q_{hyst} value z2 may be used. Alternatively, instead of network signaling a new value x, the WTRU could use one of the existing thresholds, such as Q_{qualmin}, for the value x and the network in such a case would not need to signal any new thresholds. Also, for the time interval T₁₃, the WTRU may use one of the existing time interval values signaled by the network and possibly a new time interval value T₁₃ may not need to be signaled by the network.

Alternatively, instead of defining different values, a network could signal one value (say z1) and the scalability value along with it helping the WTRU calculate z2 and z3.

Alternatively, instead of three levels, n levels could be used, where n≧2 where the thresholds could again either be implementation dependent or network defined or defined in standard after simulation results. The thresholds may be communicated dynamically via RRC messages, (e.g., in one or more SIBs)

Alternatively, the equations disclosed above can also be written as follows:

For serving cell the ranking criteria is modified as:

Rank_{—}s=RSRQₛ+Min(Q_{hyst2},Q_{hyst})+Q_{offmbms}. Equation (14)

For neighbor cell, the cell ranking is kept the same:

Rank_{—}n=RSRQₙ−Q_{offset2}+Q_{offmbms}. Equation (15)

The calculation of Q_{hyst} would be the same as mentioned above.

Alternatively, the value Q_{hyst2} or Q_{offset2} could be eliminated and the equations written as:

For serving cell the ranking criteria can be kept the same:

Rank_{—}s=RSRQₛ+Q_{hyst2}+Q_{offmbms}. Equation (16)

For neighbor cell though, the ranking criteria are modified as:

Rank_{—}n=RSRQₙ−Q_{hyst}+Q_{offmbms}. Equation (17)

The calculation of Q_{hyst} would be the same as mentioned above.

Alternatively, for serving cell the ranking criteria can be modified as:

Rank_{—}s=RSRQₛ+Q_{hyst}+Q_{offmbms}. Equation (18)

For neighbor cell, keep the cell ranking the same:

Rank_{—}n=RSRQₙ−Q_{offset2}+Q_{offmbms}. Equation (19)

The calculation of Q_{hyst} is then the same as mentioned above.

A similar set of the equations with the parameter Q_{hyst} can be applied when the measurement parameter is RSRP.

Even though the above equations are for non-hierarchical cell structure (HCS), the parameter Q_{hyst} could also be applied to the equations when HCS are used.

Note that in the previous equations, the desired the effect of MBMS could be neutralized by setting Q_{offmbms} to 0, (e.g., in case there is no MBMS service, or if one does not want to consider it in the cell reselection criteria).

Alternatively or in addition, it is disclosed that when the number of cell reselections during some time period T_{CRmax} exceeds a value N_{CR}, and a high mobility factor is detected, instead of just multiplying the Tᵣₑₛₑₗ with a scaling factor as in current UMTS systems, it is proposed to also have the option of multiplying the Q_{hyst} value by a scaling factor to reduce the rank of the serving cell. This multiplication of Q_{hyst} value with the scaling factor could be done in addition to multiplying the Tᵣₑₛₑₗ value with the scaling factor or only one of them could be multiplied with the scaling which may be decided by the WTRU itself, depending on a factor such as radio condition, or could be signaled by the network which may be cell dependent, or based on any other factor. This scaling factor for Q_{hyst} may either be the same as that used for Tᵣₑₛₑₗ, or another scaling factor for multiplying with the Q_{hyst} value may be signaled.

For the Tᵣₑₛₑₗ time interval, a multilevel reselection timer performs as follows:

If RSRQₛ>x, then the value of the Tᵣₑₛₑₗ (reselection timer) that could be used may be the same as the value of a reselection timer that is currently used in UMTS systems, (i.e., no scaling is required).

Else, if x>RSRQₛ>y for a time interval T₁₄, Tᵣₑₛₑₗ is reduced to a value z3.

Else, if RSRQₛ<y if for a time interval T₁₅, Tᵣₑₛₑₗ=0 or a very small value z2, where z1>z3>z2 and x>y.

The values x, y, z1, z2, z3, T₁₄, and T₁₅ could either be implementation dependent or network defined or defined in standard after simulation results. Time intervals T₁₄ and T₁₅ are the intervals for time for which the conditions for RSRQ have to be satisfied. They may be communicated dynamically via RRC messages, (e.g., in one or more SIBs).

In general, reselection timer adapted and made a function of RSRQₛ:

Tᵣₑₛₑₗ=function (RSRQₛ).

As seen, depending on the strength of the WTRU serving cell, Tᵣₑₛₑₗ timer is reduced for faster reselection to a neighbor cell.

Alternatively, there could be a two level threshold where above a value x, we could use a similar Tᵣₑₛₑₗ timer as current UMTS systems or a new reselection timer z1, and if the signal strength of the WTRU falls below the value x for a time interval T₁₆, either a shortened Tᵣₑₛₑₗ timer or no reselection timer is used at all. Alternatively, instead of network signaling a new value x, the WTRU could use one of the current thresholds as signaled today like Q_{qualmin} for the value x and network in such a case would not need to signal any new thresholds. Also, for the time interval T₁₆, the WTRU could use one of the existing timer values signaled by the network and possibly a new time interval value T₁₆ may not need to be signaled by the network. The time intervals T₁₄, T₁₅ and T₁₆ may be the same as the time intervals T₁₁, T₁₂ and T₁₃, or they may be different.

Alternatively, instead of defining different values, a network could signal one value (say z1) and the scalability value along with it to help the WTRU calculate z2 and z3.

Alternatively, instead of 2 or 3 levels, there could be n levels where n>=2 where the thresholds could again either be implementation dependent or network defined or defined in standard after simulation results. The thresholds or timer values may be communicated dynamically via RRC messages (e.g., in one or more SIBs).

Either the network or the WTRU could decide to use both the adaptive ranking criteria and the reselection timer or either one alone for more robust cell reselection.

For the adaptive reselection idea based on signal strength disclosed here, the multiplication of Q_{hyst} value with the scaling factor could be done in addition to multiplying the Tᵣₑₛₑₗ value with the scaling factor or only one of them could be multiplied with the scaling factor which may be decided by the WTRU itself, depending on a factor such as a radio condition, or may be signaled by the network, which could be cell dependent, or based on any other factor. This scaling factor for Q_{hyst} may either be the same as that used for Tᵣₑₛₑₗ, or another scaling factor for multiplying with the Q_{hyst} value may be signaled. Also, the scaling factor signaled for the adaptive reselection method proposed above may be same as what is currently signaled for a high mobility scenario, or another scaling factor to be used specifically for adaptive reselection based on signal strength could be signaled.

The following describes the mitigation of a handover failure caused by the serving cell falling too rapidly, in which the serving cell quality is taken into account during the handover procedure.

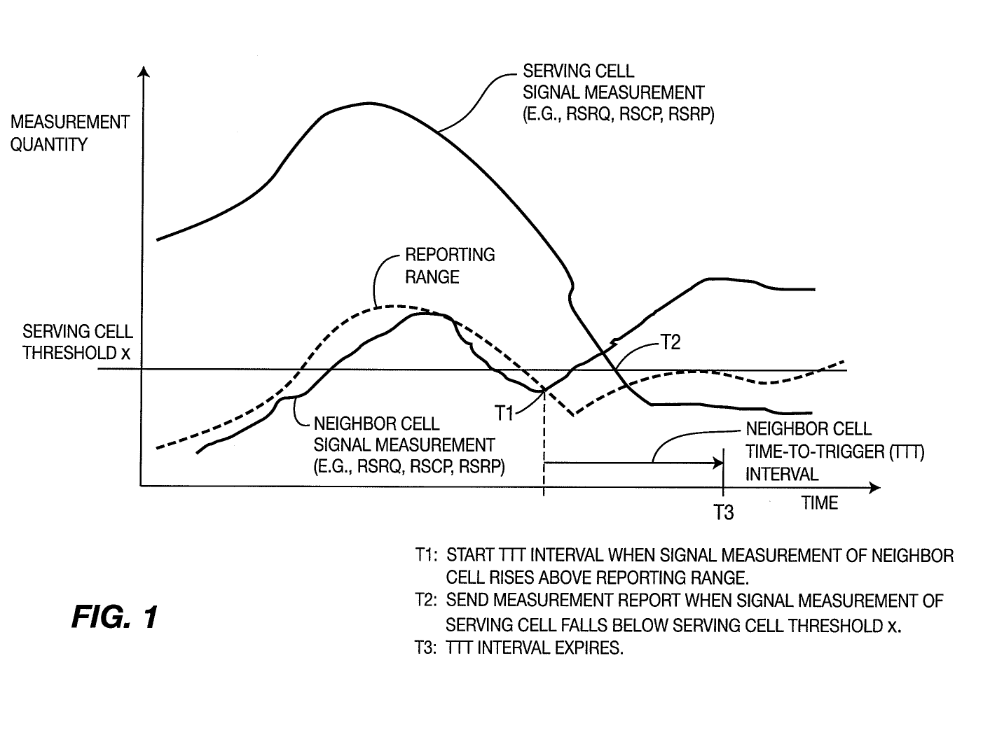

In FIG. 1, a timeline for triggering a measurement report for a serving cell signal measurement falling below a threshold is shown, where the following are assumed:

Signal measurement, (e.g., RSRQ, RSCP, RSRP), of the serving cell over time.

Signal measurement, (e.g., RSRQ, RSCP, RSRP), of the neighbor cell over time.

Serving cell threshold x: A threshold below which the serving cell sends a measurement report to the network.

Reporting Range: Value above which the TTT interval on the neighbor cell is started.

Time T1: Time when the neighbor cell rises above the reporting range to start a TTT interval.

Time T2: Time when the signal measurement of the serving cell falls below the serving cell threshold x and sends a measurement report to the network reporting that the serving cell signal measurement has fallen below the threshold and giving information about the neighbor cell on which the TTT interval is counting down.

Alternatively, instead of the value T2, a time interval T4, (not shown in FIG. 1), may be used as the amount of time the serving cell signal measurement may need to be below the serving cell threshold x. Thus, when the serving cell has been a particular threshold for the duration of the time interval T4, the WTRU may send a measurement report. Furthermore, the serving cell threshold may be one of the values already transmitted in the SIB, such as Q_{qualmin}, or the serving cell signal threshold may be transmitted separately either through a broadcast message or part of some dedicated RRC measurement control message.

Time T3: Time when the TTT interval has expired and the WTRU can report a measurement report to the network as before.

As seen in FIG. 1, when the neighbor cell signal measurement rises above the reporting range, the WTRU can start the TTT interval for the neighbor cell. During the running of TTT interval, if the serving cell signal measurement falls below a serving cell threshold x, the WTRU can send a measurement report before the expiration of the TTT interval, reporting that the serving cell signal measurement has fallen below the threshold x. The measurement report would also identify the neighbor cell on which the TTT interval is counting down, thereby requesting the network to generate a handover command immediately to hasten a handover.

Alternatively, after starting the TTT interval, the WTRU can send a measurement report that indicates that the serving cell signal measurement has fallen below the serving cell threshold x and identifies the neighbor cell on which the TTT interval is counting down, thereby requesting the network to send the handover command immediately to hasten the handover, if the serving cell signal measurement falls and remains below the serving cell threshold x for a time interval T4. If no handover command is received, and if the TTT interval expires with the neighbor cell having remained above the reporting range during the entire duration of the TTT interval, a measurement report is triggered with the appropriate event. For example, when the neighbor cell is added to an active set, and a handover command is received, the WTRU can stop its TTT interval and perform a handover procedure.

Alternatively, if no neighbor cell has met the reporting criteria, or if the neighbor cell signal measurement falls below the exit criteria during the duration of the TTT interval and the serving cell signal measurement falls below a threshold, the WTRU can still send a measurement report to the network reporting that the serving cell signal measurement has fallen below the threshold. The network may then use this information to perform a blind handover, or send a signal to the WTRU reducing the TTT interval and/or lowering the reporting range, or in any manner that it deems appropriate for that WTRU/scenario.

The serving cell threshold may be sent by the network in the SIB or measurement control message, or in any other message, or could be determined by the WTRU or may be mentioned in the standards based on simulation results.

The principles of adaptively sending a measurement report based on the serving cell threshold before the expiration of the TTT interval may be applied to intra-frequency and/or inter-frequency and/or inter-RAT handovers.

If the serving cell signal measurement is falling too rapidly, or the TTT interval is too long and the serving cell quality is degrading, a call can be saved using the methods and apparatus described above. Furthermore, by using an adaptive cell reselection and handover procedure, the WTRU is more likely to maintain service and sustain a call during a cell reselection and handover procedure.

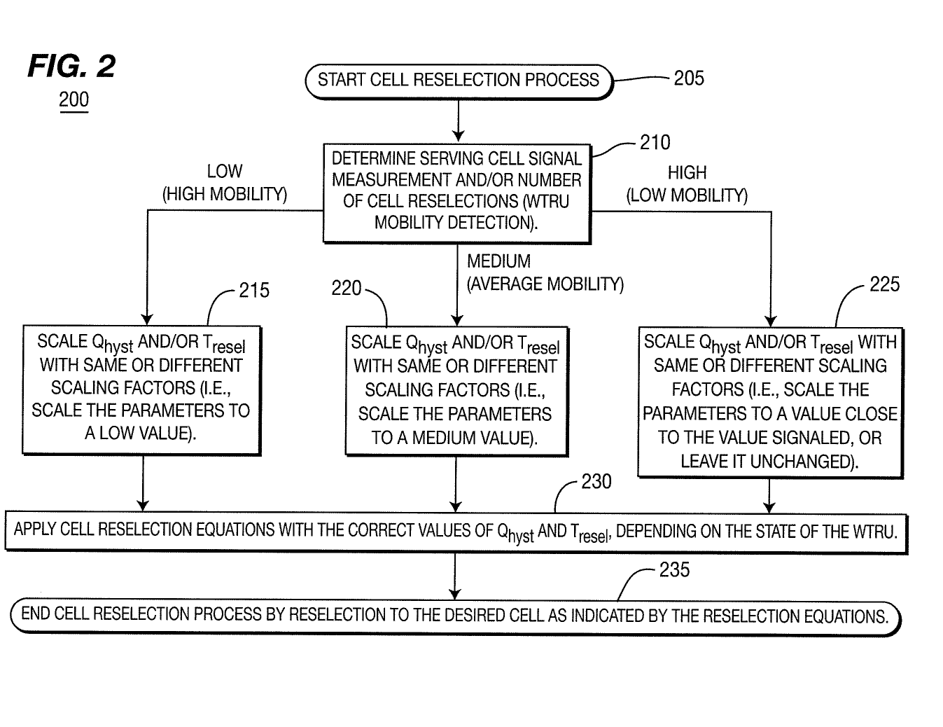

FIG. 2 is a flow diagram of a cell reselection process 200. The cell reselection process starts at step 205. At step 210, a determination is made as to what the serving cell signal measurement and/or the number of cell reselections is, (WTRU mobility detection). If the serving cell signal measurement and/or the number of cell reselections is low, indicating a high mobility, the Q_{hyst} and/or the Tᵣₑₛₑₗ are scaled at step 215 with the same or different scaling factors, (i.e., the parameters are scaled to a low value). If the serving cell signal measurement and/or the number of cell reselections is medium, indicating average mobility, the Q_{hyst} and/or the Tᵣₑₛₑₗ are scaled at step 220 with the same or different scaling factors, (i.e., the parameters are scaled to a medium value). If the serving cell signal measurement and/or the number of cell reselections is high, indicating low mobility, the Q_{hyst} and/or the Tᵣₑₛₑₗ are scaled at step 225 with the same or different scaling factors, (i.e., the parameters are scaled to the value signaled, or it is left unchanged). In step 230, the cell reselection equations are applied with the correct values of Q_{hyst} and Tᵣₑₛₑₗ, depending on the state of the WTRU. In step 235, the cell reselection process 200 ends by reselection to the desired cell as indicated by the reselection equations.

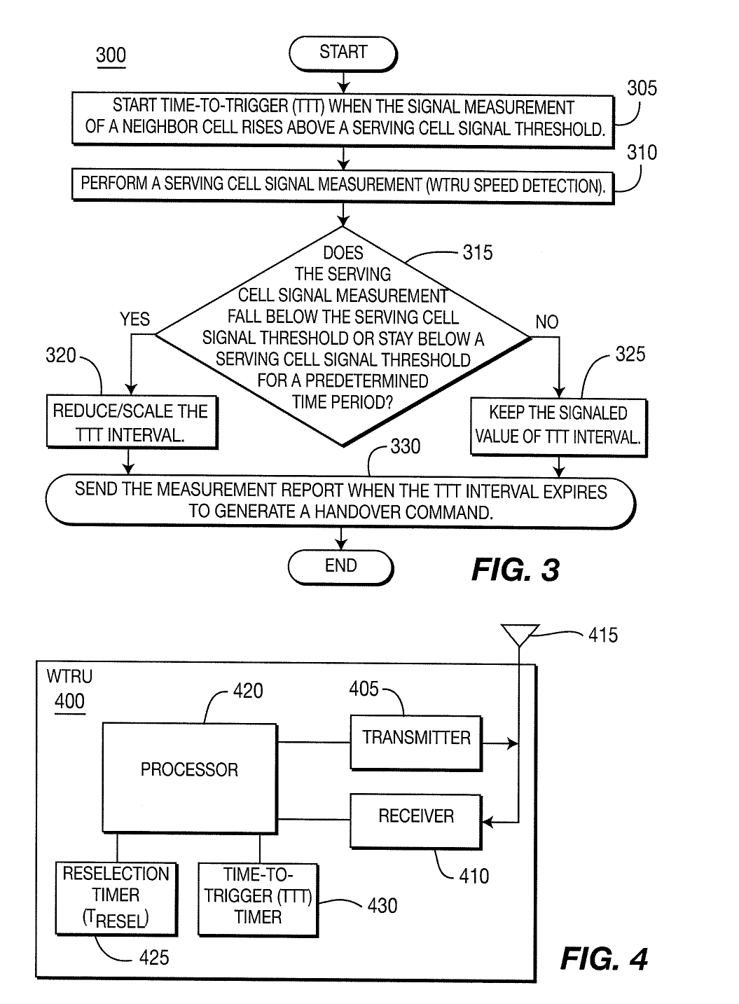

FIG. 3 is a flow diagram of a handover procedure 300 using TTT scaling. In step 305, the TTT interval is started when the signal measurement of a neighbor cell rises above a serving cell signal threshold. In step 310, a serving cell signal measurement is performed, (WTRU speed detection). In step 315, if the serving cell signal measurement falls below the serving cell signal threshold, or stays below a serving cell signal threshold for a predetermined time period, the TTT interval is reduced/scaled (step 320). Otherwise, the signaled value of the TTT interval is maintained (step 325). In step 330, a measurement report is sent when the TTT interval expires to generate a handover command.

FIG. 4 shows an example of the configuration of a WTRU 400 used to perform the methods disclosed herein. The WTRU 400 includes a transmitter 405, a receiver 410, an antenna 415, a processor 420, a reselection timer 425 and a TTT timer 430.

The receiver 410 is configured to perform a signal measurement, (e.g., RSRQ, RSCP, RSRP), of a serving cell. The processor 420 is configured to set a serving cell hysteresis value to a first value if the signal measurement of the serving cell exceeds a first threshold, set the serving cell hysteresis value to a second value if the signal measurement of the serving cell is less that the first threshold and is greater than a second threshold for a first time interval, set the serving cell hysteresis value to a third value if the signal measurement of the serving cell is less than the second threshold for a second time interval, and adjust the ranking criteria of the serving cell based on the serving cell hysteresis value after being set to one of the first value, the second value and the third value.

The receiver 410 is further configured to perform a signal measurement, (e.g., RSRQ, RSCP, RSRP), of a serving cell. The processor 420 is configured to set a neighbor cell offset value to a first value if the signal measurement of the serving cell exceeds a first threshold, set the neighbor cell offset value to a second value if the signal measurement of the serving cell is less that the first threshold and is greater than a second threshold for a first time interval, set the neighbor cell offset value to a third value if the signal measurement of the serving cell is less than the second threshold for a second time interval, and adjust the ranking criteria of the neighbor cell based on the neighbor cell offset value after being set to one of the first value, the second value and the third value.

The processor 420 is further configured to set the reselection timer 425 to a first value if the signal measurement of the serving cell exceeds a first threshold, set the reselection timer 425 to a second value if the signal measurement of the serving cell is less that the first threshold and is greater than a second threshold for a first time interval, and set the reselection timer 425 to a third value if the signal measurement of the serving cell is less than the second threshold for a second time interval.

The receiver 410 is further configured to perform a serving cell signal measurement and a neighbor cell signal measurement. The processor 420 is further configured to start a TTT interval established by the TTT timer 430 when the neighbor cell signal measurement rises above a reporting range threshold and adjust the TTT interval. The transmitter 405 is configured to transmit a measurement report before the expiration of the TTT interval if the serving cell signal measurement falls below a serving cell threshold, the measurement report indicating that the serving cell signal measurement has fallen below the serving cell threshold and provide information about the neighbor cell used to generate a handover command. The transmitter 405 is further configured to transmit a measurement report during the TTT interval if the serving cell signal measurement falls below a serving cell threshold and stays below the threshold during a predetermined time interval.

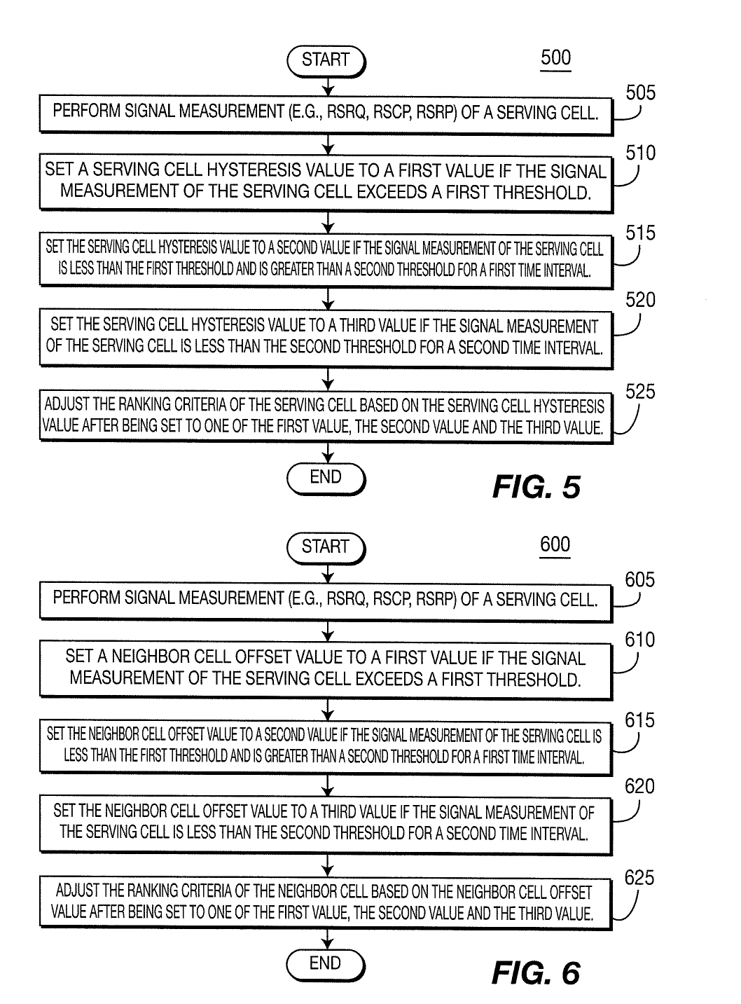

FIG. 5 is a flow diagram of a wireless communication method 500 of adjusting the ranking criteria of a serving cell associated with a WTRU. In step 505, a signal measurement, (e.g., RSRQ, RSCP, RSRP), of the serving cell is performed. In step 510, a serving cell hysteresis value is set to a first value if the signal measurement of the serving cell exceeds a first threshold. In step 515, the serving cell hysteresis value is set to a second value if the signal measurement of the serving cell is less that the first threshold and is greater than a second threshold for a first time interval. In step 520, the serving cell hysteresis value is set to a third value if the signal measurement of the serving cell is less than the second threshold for a second time interval. In step 525, the ranking criteria of the serving cell is adjusted based on the serving cell hysteresis value after being set to one of the first value, the second value and the third value.

FIG. 6 is a flow diagram of a wireless communication method 600 of adjusting the ranking criteria of a neighbor cell associated with a WTRU. In step 605, a signal measurement, (e.g., RSRQ, RSCP, RSRP), of the serving cell is performed. In step 610, a neighbor cell offset value is set to a first value if the signal measurement of the serving cell exceeds a first threshold. In step 615, the neighbor cell offset value is set to a second value if the signal measurement of the serving cell is less that the first threshold and is greater than a second threshold for a first time interval. In step 620, the neighbor cell offset value is set to a third value if the signal measurement of the serving cell is less than the second threshold for a second time interval. In step 625, the ranking criteria of the neighbor cell is adjusted based on the neighbor cell offset value after being set to one of the first value, the second value and the third value.

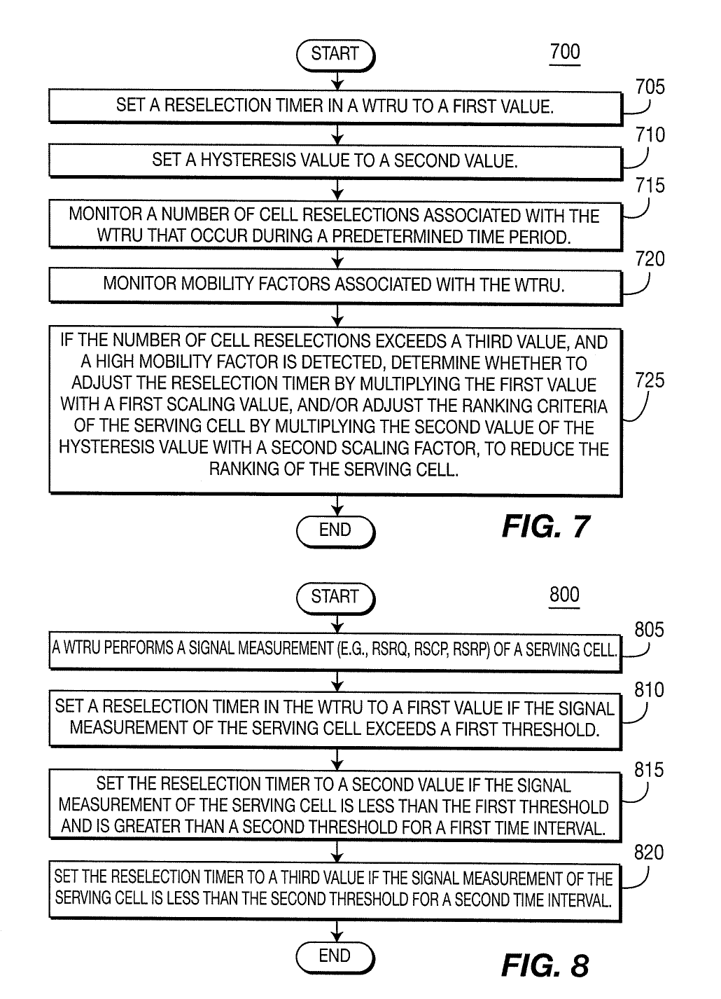

FIG. 7 is a flow diagram of a wireless communication method 700 of adjusting the ranking criteria of a serving cell associated with a WTRU. In step 705, a reselection timer in the WTRU is set to a first value. In step 710, a hysteresis value is set to a second value. In step 715, a number of cell reselections associated with the WTRU that occur during a predetermined time period are monitored. In step 720, mobility factors associated with the WTRU are monitored. In step 725, if the number of cell reselections exceeds a third value, and a high mobility factor is detected, a determination is made as to whether a first adjustment of the reselection timer should be performed by multiplying the first value with a first scaling factor, a second adjustment of the ranking criteria of the serving cell should be performed by multiplying the second value of the hysteresis value with a second scaling factor, or both of the first and second adjustments should be performed, to reduce the ranking of the serving cell.

FIG. 8 is a flow diagram of a wireless communication method 800 of adjusting a reselection timer in a WTRU. In step 805, a signal measurement, (e.g., RSRQ, RSCP, RSRP), of a serving cell is performed by the WTRU. In step 810, a reselection timer in the WTRU is set to a first value if the signal measurement of the serving cell exceeds a first threshold. In step 815, the reselection timer is set to a second value if the signal measurement of the serving cell is less that the first threshold and is greater than a second threshold for a first time interval. In step 820, the reselection timer is set to a third value if the signal measurement of the serving cell is less than the second threshold for a second time interval.

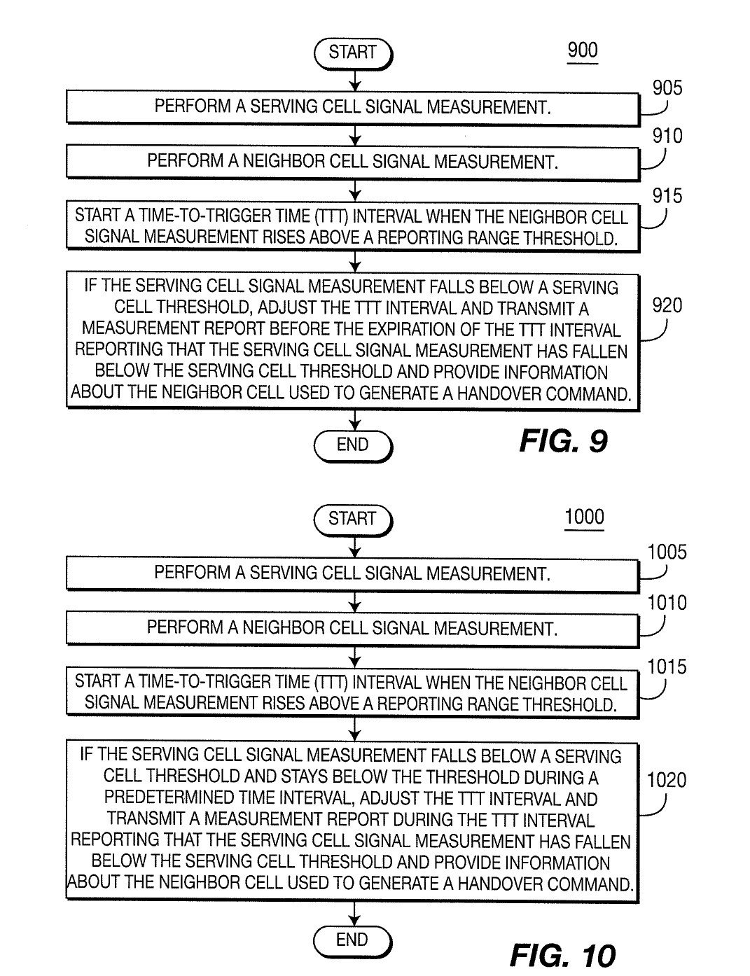

FIG. 9 is a flow diagram of a cell signal measurement reporting method 900 performed by a WTRU. In step 905, a serving cell signal measurement is performed. In step 910, a neighbor cell signal measurement is performed. In step 915, a TTT interval is started when the neighbor cell signal measurement rises above a reporting range threshold. In step 920, if the serving cell signal measurement falls below a serving cell threshold, the TTT interval is adjusted and a measurement report is transmitted before the expiration of the TTT interval, reporting that the serving cell signal measurement has fallen below the serving cell threshold and providing information about the neighbor cell used to generate a handover command.

FIG. 10 is a flow diagram of a cell signal measurement reporting method 1000 performed by a WTRU. In step 1005, a serving cell signal measurement is performed. In step 1010, a neighbor cell signal measurement is performed. In step 1015, a TTT interval is started when the neighbor cell signal measurement rises above a reporting range threshold. In step 1020, if the serving cell signal measurement falls below a serving cell threshold and stays below the threshold during a predetermined time interval, the TTT interval is adjusted and a measurement report is transmitted during the TTT interval, reporting that the serving cell signal measurement has fallen below the serving cell threshold and providing information about the neighbor cell used to generate a handover command.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

1. A wireless communication method of adjusting the ranking criteria of a serving cell associated with a wireless transmit/receive unit (WTRU), the method comprising:
performing a signal measurement of a serving cell;
setting a serving cell hysteresis value to a first value if the signal measurement of the serving cell exceeds a first threshold;
setting the serving cell hysteresis value to a second value if the signal measurement of the serving cell is less that the first threshold and is greater than a second threshold for a first time interval;
setting the serving cell hysteresis value to a third value if the signal measurement of the serving cell is less than the second threshold for a second time interval; and
adjusting the ranking criteria of the serving cell based on the serving cell hysteresis value after being set to one of the first value, the second value and the third value.

2. The method of claim 1 wherein the serving cell signal measurement is reference symbol received quality (RSRQ) and the first and second thresholds are RSRQ thresholds.

3. The method of claim 1 wherein the serving cell signal measurement is received signal code power (RSCP) and the first and second thresholds are RSCP thresholds.

4. The method of claim 1 wherein the serving cell signal measurement is reference signal received power (RSRP) and the first and second thresholds are RSRP thresholds.

5. The method of claim 1 wherein the serving cell signal measurement is used to calculate different levels of speed associated with the WTRU.

6. The method of claim 1 wherein the first value is greater than the second value, the second value is greater than the third value, and the first threshold is greater than the second threshold.

7. The method of claim 1 wherein the first, second and third values are signaled by a network.

8. The method of claim 1 wherein the first value and at least one scaling factor are signaled by a network, and the second and third values are derived from the first value using the at least one scaling factor.

9. The method of claim 1 further comprising:
adjusting a time value of a reselection timer located in the WTRU based on how the signal measurement compares to the first and second thresholds.

10. The method of claim 1 further comprising:
receiving a radio resource control (RRC) message indicating at least one of the first threshold and the second threshold.

11. The method of claim 1 further comprising:
receiving a radio resource control (RRC) message indicating at least one of the first value, the second value and the third value.

12. A wireless communication method of adjusting the ranking criteria of a neighbor cell associated with a wireless transmit/receive unit (WTRU), the method comprising:
performing a signal measurement of a serving cell;
setting a neighbor cell offset value to a first value if the signal measurement of the serving cell exceeds a first threshold;
setting the neighbor cell offset value to a second value if the signal measurement of the serving cell is less that the first threshold and is greater than a second threshold for a first time interval;
setting the neighbor cell offset value to a third value if the signal measurement of the serving cell is less than the second threshold for a second time interval; and
adjusting the ranking criteria of the neighbor cell based on the neighbor cell offset value after being set to one of the first value, the second value and the third value.

13. The method of claim 12 wherein the serving cell signal measurement is reference symbol received quality (RSRQ) and the first and second thresholds are RSRQ thresholds.

14. The method of claim 12 wherein the serving cell signal measurement is received signal code power (RSCP) and the first and second thresholds are RSCP thresholds.

15. The method of claim 12 wherein the serving cell signal measurement is reference signal received power (RSRP) and the first and second thresholds are RSRP thresholds.

16. The method of claim 12 wherein the serving cell signal measurement is used to calculate different levels of speed associated with the WTRU.

17. The method of claim 12 wherein the first value is greater than the second value, the second value is greater than the third value, and the first threshold is greater than the second threshold.

18. The method of claim 12 wherein the first, second and third values are signaled by a network.

19. The method of claim 12 wherein the first value and at least one scaling factor are signaled by a network, and the second and third values are derived from the first value using the at least one scaling factor.

20. The method of claim 12 further comprising:
adjusting a time value of a reselection timer located in the WTRU based on how the signal measurement compares to the first and second thresholds.

21. The method of claim 12 further comprising:
receiving a radio resource control (RRC) message indicating at least one of the first threshold and the second threshold.

22. The method of claim 12 further comprising:
receiving a radio resource control (RRC) message indicating at least one of the first value, the second value and the third value.

23. A wireless transmit/receive unit (WTRU) comprising:
a receiver configured to perform a signal measurement of a serving cell; and
a processor configured to set a serving cell hysteresis value to a first value if the signal measurement of the serving cell exceeds a first threshold, set the serving cell hysteresis value to a second value if the signal measurement of the serving cell is less that the first threshold and is greater than a second threshold for a first time interval, set the serving cell hysteresis value to a third value if the signal measurement of the serving cell is less than the second threshold for a second time interval, and adjust the ranking criteria of the serving cell based on the serving cell hysteresis value after being set to one of the first value, the second value and the third value.

24. The WTRU of claim 23 wherein the serving cell signal measurement is reference symbol received quality (RSRQ) and the first and second thresholds are RSRQ thresholds.

25. The WTRU of claim 23 wherein the serving cell signal measurement is received signal code power (RSCP) and the first and second thresholds are RSCP thresholds.

26. The WTRU of claim 23 wherein the serving cell signal measurement is reference signal received power (RSRP) and the first and second thresholds are RSRP thresholds.

27. The WTRU of claim 23 wherein the serving cell signal measurement is used to calculate different levels of speed associated with the WTRU.

28. The WTRU of claim 23 wherein the first value is greater than the second value, the second value is greater than the third value, and the first threshold is greater than the second threshold.

29. The WTRU of claim 23 wherein the first, second and third values are signaled by a network.

30. The WTRU of claim 23 wherein the first value and at least one scaling factor are signaled by a network, and the second and third values are derived from the first value using the at least one scaling factor.

31. The WTRU of claim 23 further comprising:
a reselection timer, wherein a time value of the reselection timer is adjusted based on how the signal measurement compares to the first and second thresholds.

32. The WTRU of claim 23 wherein the receiver is further configured to receive a radio resource control (RRC) message indicating at least one of the first threshold and the second threshold.

33. The WTRU of claim 23 wherein the receiver is further configured to receive a radio resource control (RRC) message indicating at least one of the first value, the second value and the third value.

34. A wireless transmit/receive unit (WTRU) comprising:
a receiver configured to perform a signal measurement of a serving cell; and
a processor configured to set a neighbor cell offset value to a first value if the signal measurement of the serving cell exceeds a first threshold, set the neighbor cell offset value to a second value if the signal measurement of the serving cell is less that the first threshold and is greater than a second threshold for a first time interval, set the neighbor cell offset value to a third value if the signal measurement of the serving cell is less than the second threshold for a second time interval, and adjust the ranking criteria of the neighbor cell based on the neighbor cell offset value after being set to one of the first value, the second value and the third value.

35. The WTRU of claim 34 wherein the serving cell signal measurement is reference symbol received quality (RSRQ) and the first and second thresholds are RSRQ thresholds.

36. The WTRU of claim 34 wherein the serving cell signal measurement is received signal code power (RSCP) and the first and second thresholds are RSCP thresholds.

37. The WTRU of claim 34 wherein the serving cell signal measurement is reference signal received power (RSRP) and the first and second thresholds are RSRP thresholds.

38. The WTRU of claim 34 wherein the serving cell signal measurement is used to calculate different levels of speed associated with the WTRU.

39. The WTRU of claim 34 wherein the first value is greater than the second value, the second value is greater than the third value, and the first threshold is greater than the second threshold.

40. The WTRU of claim 34 wherein the first, second and third values are signaled by a network.

41. The WTRU of claim 34 wherein the first value and at least one scaling factor are signaled by a network, and the second and third values are derived from the first value using the at least one scaling factor.

42. The WTRU of claim 34 further comprising:
a reselection timer, wherein a time value of the reselection timer is adjusted based on how the signal measurement compares to the first and second thresholds.

43. The WTRU of claim 34 wherein the receiver is further configured to receive a radio resource control (RRC) message indicating at least one of the first threshold and the second threshold.

44. The WTRU of claim 34 wherein the receiver is further configured to receive a radio resource control (RRC) message indicating at least one of the first value, the second value and the third value.

45. A wireless transmit/receive unit (WTRU) comprising:
a reselection timer;
a receiver configured to perform a signal measurement of a serving cell; and
a processor configured to set the reselection timer to a first value if the signal measurement of the serving cell exceeds a first threshold, set the reselection timer to a second value if the signal measurement of the serving cell is less that the first threshold and is greater than a second threshold for a first time interval, and set the reselection timer to a third value if the signal measurement of the serving cell is less than the second threshold for a second time interval.

46. The WTRU of claim 45 wherein the serving cell signal measurement is reference symbol received quality (RSRQ) and the first and second thresholds are RSRQ thresholds.

47. The WTRU of claim 45 wherein the serving cell signal measurement is received signal code power (RSCP) and the first and second thresholds are RSCP thresholds.

48. The WTRU of claim 45 wherein the serving cell signal measurement is reference signal received power (RSRP) and the first and second thresholds are RSRP thresholds.

49. The WTRU of claim 45 wherein the serving cell signal measurement is used to calculate different levels of speed associated with the WTRU.

50. The WTRU of claim 45 wherein the first value is greater than the second value, the second value is greater than the third value, and the first threshold is greater than the second threshold.

51. The WTRU of claim 45 wherein the first, second and third values are signaled by a network.

52. The WTRU of claim 45 wherein the first value and at least one scaling factor are signaled by a network, and the second and third values are derived from the first value using the at least one scaling factor.

53. The WTRU of claim 45 wherein the receiver is further configured to receive a radio resource control (RRC) message indicating at least one of the first threshold and the second threshold.

54. The WTRU of claim 45 wherein the receiver is further configured to receive a radio resource control (RRC) message indicating at least one of the first value, the second value and the third value.

55. A wireless communication method of adjusting the ranking criteria of a serving cell associated with a wireless transmit/receive unit (WTRU), the method comprising:
setting a reselection timer in the WTRU to a first value;
setting a hysteresis value to a second value;
monitoring a number of cell reselections associated with the WTRU that occur during a predetermined time period;
monitoring mobility factors associated with the WTRU; and
if the number of cell reselections exceeds a third value, and a high mobility factor is detected, determining whether to perform a first adjustment of the reselection timer by multiplying the first value with a first scaling factor, perform a second adjustment by multiplying the second value of the hysteresis value with a second scaling factor, or perform both of the first and second adjustments, to reduce the ranking of the serving cell.

56. The method of claim 55 wherein the determination as to whether or not to perform both of the first and second adjustments is based on a radio condition.

57. The method of claim 55 wherein the first scaling factor is the same as the second scaling factor.

58. The method of claim 55 wherein the first scaling factor is different than the second scaling factor.

59. The method of claim 55 wherein the first value indicates a time for which a neighbor cell is expected to meet a cell reselection criteria for the WTRU.

60. The method of claim 55 further comprising:
receiving a radio resource control (RRC) message indicating at least one of the first scaling factor and the second scaling factor.

61. A wireless transmit/receive unit (WTRU) comprising:
a receiver configured to monitor mobility factors associated with the WTRU;
a reselection timer; and
a processor configured to monitor a number of cell reselections associated with the WTRU that occur during a predetermined time period, set the reselection timer to a first value, set a hysteresis value to a second value, and determine whether to perform a first adjustment of the reselection timer by multiplying the first value with a first scaling factor, perform a second adjustment by multiplying the second value of the hysteresis value with a second scaling factor, or perform both of the first and second adjustments, to reduce the ranking of the serving cell, if the number of cell reselections exceeds a third value, and a high mobility factor is detected.

62. The WTRU of claim 61 wherein a determination as to whether or not to perform both of the first and second adjustments is based on a radio condition.

63. The WTRU of claim 61 wherein the first scaling factor is the same as the second scaling factor.

64. The WTRU of claim 61 wherein the first scaling factor is different than the second scaling factor.

65. The WTRU of claim 61 wherein the first value indicates a time for which a neighbor cell is expected to meet a cell reselection criteria for the WTRU.

66. The WTRU of claim 61 wherein the receiver is further configured to receive a radio resource control (RRC) message indicating at least one of the first scaling factor and the second scaling factor.

67. A cell signal measurement reporting method performed by a wireless transmit/receive unit (WTRU), the method comprising:
performing a serving cell signal measurement;
performing a neighbor cell signal measurement;
starting a time-to-trigger time (TTT) interval when the neighbor cell signal measurement rises above a reporting range threshold; and
if the serving cell signal measurement falls below a serving cell threshold, adjusting the TTT interval and transmitting a measurement report before the expiration of the TTT interval reporting that the serving cell signal measurement has fallen below the serving cell threshold and providing information about the neighbor cell used to generate a handover command.

68. The method of claim 67 wherein the serving cell signal measurement is used to calculate different levels of speed associated with the WTRU.

69. The method of claim 67 wherein the handover command is associated with at least one of an intra-frequency handover, an inter-frequency handover and an inter-radio access technology (inter-RAT) handover.

70. A cell signal measurement reporting method performed by a wireless transmit/receive unit (WTRU), the method comprising:
performing a serving cell signal measurement;
performing a neighbor cell signal measurement;
starting a time-to-trigger time (TTT) interval when the neighbor cell signal measurement rises above a reporting range threshold; and
if the serving cell signal measurement falls below a serving cell threshold and stays below the threshold during a predetermined time interval, adjusting the TTT interval and transmitting a measurement report during the TTT interval reporting that the serving cell signal measurement has fallen below the serving cell threshold and providing information about the neighbor cell used to generate a handover command.

71. The method of claim 70 wherein the serving cell signal measurement is used to calculate different levels of speed associated with the WTRU.

72. The method of claim 70 wherein the handover command is associated with at least one of an intra-frequency handover, an inter-frequency handover and an inter-radio access technology (inter-RAT) handover.

73. A wireless transmit/receive unit (WTRU) comprising:
a receiver configured to perform a serving cell signal measurement and a neighbor cell signal measurement;
a time-to-trigger time (TTT) timer;
a processor configured to start a TTT interval established by the TTT timer when the neighbor cell signal measurement rises above a reporting range threshold and adjust the TTT interval; and
a transmitter configured to transmit a measurement report before the expiration of the TTT interval if the serving cell signal measurement falls below a serving cell threshold, the measurement report indicating that the serving cell signal measurement has fallen below the serving cell threshold and provide information about the neighbor cell used to generate a handover command.

74. The WTRU of claim 73 wherein the serving cell signal measurement is used to calculate different levels of speed associated with the WTRU.

75. The method of claim 73 wherein the handover command is associated with at least one of an intra-frequency handover, an inter-frequency handover and an inter-radio access technology (inter-RAT) handover.

76. A wireless transmit/receive unit (WTRU) comprising:
a receiver configured to perform a serving cell signal measurement and a neighbor cell signal measurement;
a time-to-trigger time (TTT) timer; and
a processor configured to start a TTT interval established by the TTT timer when the neighbor cell signal measurement rises above a reporting range threshold and adjust the TTT interval; and
a transmitter configured to transmit a measurement report during the TTT interval if the serving cell signal measurement falls below a serving cell threshold and stays below the threshold during a predetermined time interval, the measurement report indicating that the serving cell signal measurement has fallen below the serving cell threshold and provide information about the neighbor cell used to generate a handover command.

77. The WTRU of claim 76 wherein the serving cell signal measurement is used to calculate different levels of speed associated with the WTRU.

78. The method of claim 76 wherein the handover command is associated with at least one of an intra-frequency handover, an inter-frequency handover and an inter-radio access technology (inter-RAT) handover.

79. A wireless communication method of adjusting the ranking criteria of a serving cell associated with a wireless transmit/receive unit (WTRU), the method comprising:
establishing a plurality of thresholds;
performing a signal measurement of a serving cell;
setting a hysteresis value to a particular value that depends upon how the serving cell signal measurement compares to the plurality of thresholds; and
adjusting the ranking criteria of the serving cell based on the hysteresis value after being set to the particular value.

80. The method of claim 79 wherein the serving cell signal measurement is reference symbol received quality (RSRQ).

81. The method of claim 79 wherein the serving cell signal measurement is received signal code power (RSCP).

82. The method of claim 79 wherein the serving cell signal measurement is reference signal received power (RSRP).

83. The method of claim 79 wherein the serving cell signal measurement is used to calculate different levels of speed associated with the WTRU.

84. A wireless communication method of adjusting a reselection timer in a wireless transmit/receive unit (WTRU), the method comprising:
establishing a plurality of thresholds;
performing a signal measurement of a serving cell; and
adjusting the reselection timer based on the how the serving cell signal measurement compares to the plurality of thresholds.

85. The method of claim 84 wherein the serving cell signal measurement is reference symbol received quality (RSRQ).

86. The method of claim 84 wherein the serving cell signal measurement is received signal code power (RSCP).

87. The method of claim 84 wherein the serving cell signal measurement is reference signal received power (RSRP).

88. The method of claim 84 wherein the serving cell signal measurement is used to calculate different levels of speed associated with the WTRU.

89. A wireless communication method of adjusting the ranking criteria of a neighbor cell associated with a wireless transmit/receive unit (WTRU), the method comprising:
establishing a plurality of thresholds;
performing a signal measurement of a serving cell;
setting a neighbor cell offset value to a particular value that depends upon how the serving cell signal measurement compares to the plurality of thresholds; and
adjusting the ranking criteria of the neighbor cell based on the neighbor cell offset value after being set to the particular value.

90. The method of claim 89 wherein the serving cell signal measurement is reference symbol received quality (RSRQ).

91. The method of claim 89 wherein the serving cell signal measurement is received signal code power (RSCP).

92. The method of claim 89 wherein the serving cell signal measurement is reference signal received power (RSRP).

93. The method of claim 89 wherein the serving cell signal measurement is used to calculate different levels of speed associated with the WTRU.

94. A wireless communication method of adjusting a reselection timer in a wireless transmit/receive unit (WTRU), the method comprising:
establishing a plurality of thresholds;
performing a signal measurement of a serving cell; and
adjusting the reselection timer based on the how the serving cell signal measurement compares to the plurality of thresholds.

95. The method of claim 94 wherein the serving cell signal measurement is reference symbol received quality (RSRQ).

96. The method of claim 94 wherein the serving cell signal measurement is received signal code power (RSCP).

97. The method of claim 94 wherein the serving cell signal measurement is reference signal received power (RSRP).

98. The method of claim 94 wherein the serving cell signal measurement is used to calculate different levels of speed associated with the WTRU.
